(19) United States
(12) Patent Application Publication
(10) Pub. No.: US 2016/0208827 A1
(43) Pub. Date: Jul. 21, 2016

(54) COVER OF CYLINDER ROD

(71) Applicant: AMAGASAKI JYUKI CO., LTD., Hyogo (JP)

(72) Inventor: Hisashi NISHIO, Hyogo (JP)

(21) Appl. No.: 14/895,363

(22) PCT Filed: Jun. 5, 2015
(86) PCT No.: PCT/JP2015/066365

§ 371 Date: Dec. 2, 2015

(30) Foreign Application Priority Data
Jan. 16, 2015 (JP) 2015-007023

(51) Int. Cl. F15B 15/14; E02F 9/24

(52) U.S. Cl. CPC F15B 15/1423; E02F 9/24

(57) ABSTRACT

There is provided a cover of a cylinder rod which is less breakable than prior art, which does not obstruct extension and contraction of a hydraulic cylinder when the cover breaks, and which is easy to remove and replace. The cover of the cylinder rod is supported on a columnar outer face of the cylinder rod by one-point support with a mounting portion, which is joined only to an end portion of the cylinder rod, and kept out of contact with an outer peripheral face of a cylinder tube and includes a cover main body having a greater overall length than a maximum exposed length of the cylinder rod.

### TECHNICAL FIELD

The present invention relates to a cover of a cylinder rod provided to a work machine such as a crane truck, a loading shovel, and an aerial work platform and particularly to a technique for making the cover less breakable and easy to remove and replace.

### BACKGROUND ART

Conventionally, a work machine such as a crane truck, a loading shovel, and an aerial work platform is provided with hydraulic cylinders such as a boom cylinder, an arm cylinder, and a bucket cylinder as actuators, in general. When the hydraulic cylinder extends and contracts, a cylinder rod comes out of and into a cylinder tube and therefore the cylinder rod becomes uncovered.

If the uncovered cylinder rod comes in contact with an obstruction such as a construction, earth and sand, a rock, and a bucket of the work machine itself at a site and becomes deformed, the hydraulic cylinder cannot extend and contract and the work has to be suspended until the hydraulic cylinder is repaired or replaced. Moreover, the earth and sand spilt from the bucket may hit and scratch a surface of the uncovered cylinder rod, which damages an oil seal to cause an oil leak.

Therefore, a work machine and a construction machine having cylinder rods of hydraulic cylinders provided with protective covers so that the cylinder rods are not deformed or scratched are respectively disclosed in Patent Documents 1 and 2. The cover of the cylinder rod disclosed in each of Patent Documents 1 and 2 is supported at two positions of the cylinder rod and a cylinder tube. Specifically, the cylinder rod cover is fixed by a bolt to the cylinder rod and has a slide mechanism including a guide body which is mounted to the cylinder tube by screws and by which the cylinder rod cover is guided for sliding. The cylinder rod cover protects the cylinder rod portion as the rod portion extends and contracts.

### CITATION LIST

### Patent Literature

Patent Literature 1: Japanese Laid-Open Patent Publication No. 2010-037775

Patent Literature 2: Japanese Laid-Open Patent Publication No. 2002-013507

### SUMMARY OF THE INVENTION

### Problems to be Solved by the Invention

If the cylinder rod is provided with the protective cover in this manner, the cylinder rod can be protected from deformation and scratch in coming in contact with obstructions during work. On the other hand, however, the cover or the slide mechanism may break to obstruct extension and contraction of the hydraulic cylinder and the work has to be suspended until the cover or the slide mechanism is repaired.

The present invention has been made with the above-described prior-art problems in view and its object is to provide a cover of a cylinder rod which is less breakable than the prior art, which does not obstruct extension and contraction of the hydraulic cylinder when the cover breaks, and which is easy to remove and replace.

### Solutions to the Problems

A cover of a cylinder rod provided to a work machine, comprising:

the cover of the cylinder rod is supported on a columnar outer face of the cylinder rod by one-point support with a mounting portion, which is joined only to an end portion of the cylinder rod directly,

furthermore, the cover and the cylinder tube kept out of contact for overall length regardless of direct or indirect without locating any guide material with an outer peripheral face of a cylinder tube,

and includes a cover main body having a greater length than a maximum exposed length of the cylinder rod.

In the present invention,

the cover main body is preferably made of material having a smaller specific gravity than iron.

In the present invention,

the cover main body is preferably made of resin.

In the present invention,

the cover main body is preferably made of polyethylene, polypropylene, polycarbonate, acrylonitrile-butadiene-styrene resin copolymerized synthetic resin, fiber reinforced plastic, and glass fiber.

In the present invention,

the mounting portion is preferably fitted over the columnar outer face of the cylinder rod.

### Advantageous Effects of the Invention

According to the cover of the cylinder rod of the invention, because the cover has the mounting portion which is joined to the end portion of the cylinder rod to support the cover on the columnar outer face of the cylinder rod, the cover can be directly fixed to the columnar outer face of the end portion of the cylinder rod. Moreover, it is possible to bring the cover close to the cylinder rod to thereby make the cover compact. Therefore, the cover is not supported on the cylinder tube but supported only on the cylinder rod unlike the prior-art cover of the cylinder rod, which makes the slide mechanism and the guide body used for the prior-art cover of the cylinder rod unnecessary. Consequently, the cover of the cylinder rod according to the invention is less breakable than the prior art, does not obstruct extension and contraction of the hydraulic cylinder when the cover breaks, and which is easy to remove and replace.

According to the cover of the cylinder rod of the invention, because the cover main body is made of material having a smaller specific gravity than iron, the cover can be lighter than the prior-art cover mainly made of iron. Therefore, the cover main body can be easily supported by one-point support with the mounting portion.

According to the cover of the cylinder rod of the invention, because the cover main body is made of resin, it is possible to impart elasticity and resiliency to the cover main body. As a result, the cover main body can withstand a greater impact than the prior art and deformation of the cover main body due to the impact can be minimized. Furthermore, if the cover main body is made of transparent resin and when the cover main body receives an impact and cracks, an inner crack can be visually recognized. Therefore, it is easy to know when it is time for replacement, which facilitates maintenance. Moreover, the cover main body made of the transparent resin provides a wide vision, visually stimulates a sense of beauty, and attracts people's attention, which improves workability and safety and is expected to exert promotional effect.

According to the cover of the cylinder rod of the invention, because the cover main body is made of polyethylene, polypropylene, polycarbonate, acrylonitrile-butadiene-styrene copolymerized synthetic resin, fiber reinforced plastic, or glass fiber, the cover main body has improved impact resistance, workability, and safety.

### BRIEF DESCRIPTION OF THE DRAWINGS

FIG. 1 is a side view showing an outward appearance of a work machine according to embodiment 1.

FIGS. 2(a), 2(b), and 2(c) are a front view, a side view, and a back view showing an outward appearance of a cover of a cylinder rod according to embodiment 1.

FIG. 3 is a diagram showing the cover of the cylinder rod according to embodiment 1 before and after mounting.

FIG. 4 is a side view showing an outward appearance of a straight cover of the cylinder rod.

FIG. 5 is an enlarged sectional view along line A-A in FIG. 4.

### DESCRIPTION OF EMBODIMENTS

A cover of a cylinder rod and a work machine according to an embodiment of the present invention will be described below with reference to the drawings. In the following description, the same parts are provided with the same reference signs.

### Embodiment 1

The cover of the cylinder rod according to the invention is supported on a columnar outer face of the cylinder rod by one-point support with a mounting portion, which is joined only to an end portion of the cylinder rod, and kept out of contact with an outer peripheral face of a cylinder tube and includes a cover main body having a greater overall length than a maximum exposed length of the cylinder rod.

Because the cover of the cylinder rod in the invention has the mounting portion which is joined to the end portion of the cylinder rod to support the cover on the columnar outer face of the cylinder rod, the cover can be directly fixed to the columnar outer face of the end portion of the cylinder rod. Moreover, it is possible to bring the cover close to the cylinder rod to thereby make the cover compact.

Because the cover main body is made of material having a smaller specific gravity than iron, the cover can be supported at only one position of the cylinder rod without necessity of being supported at two positions of the cylinder tube and the cylinder rod unlike the prior-art cover of the cylinder rod and does not require the slide mechanism and the guide used in the prior art. Therefore, the cover of the cylinder rod of the invention is less breakable than the prior-art cover, does not obstruct extension and contraction of the hydraulic cylinder when it breaks, and is easy to remove and replace.

The method of joining the cover of the cylinder rod in the invention is not especially limited, if the cover has the mounting portion which is joined to the end portion of the cylinder rod to support the cover on the columnar outer face of the cylinder rod. For example, the method of joining can be suitably selected according to an existing portion of a clevis portion on the cylinder rod. To put it concretely, if the existing portion (specifically, an internal thread) exists, it is possible to employ a method in which the mounting portion is fastened. If the existing portion does not exist, on the other hand, it is possible to employ a method in which the mounting portion is directly welded to a desired position of the clevis portion.

From a view point of workability of the mounting portion to be joined to the end portion of the cylinder rod of an actual work machine, the mounting portion is preferably fitted over the columnar outer face of the cylinder rod.

The invention will be described below by taking a case in which the mounting portion of the cover of the cylinder rod provided to the work machine is fitted over the columnar outer face of the cylinder rod as an example.

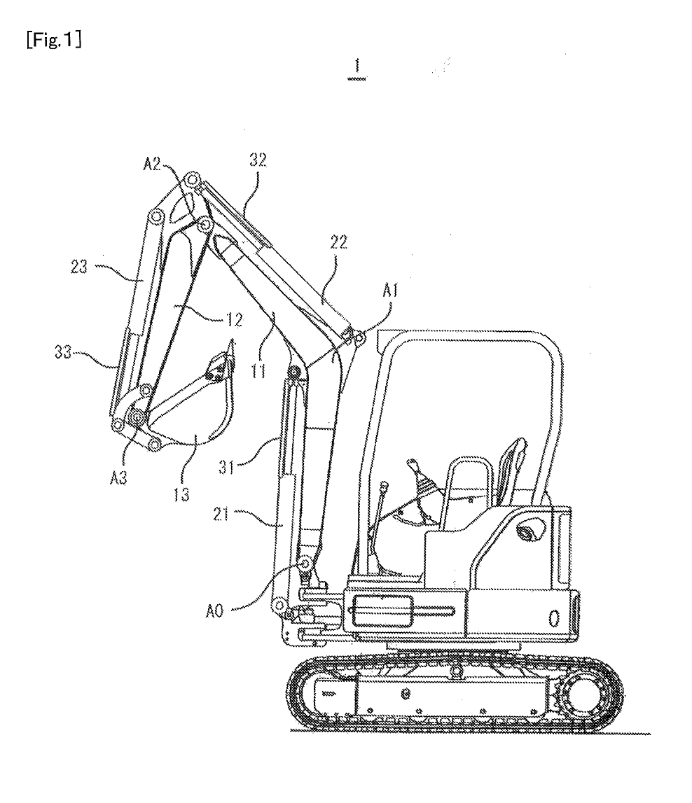

FIG. 1 is a side view showing an outward appearance of a work machine 1 according to embodiment 1. The work machine 1 is a small loading shovel, for example, and includes a movable portion, a plurality of hydraulic cylinders for causing the movable portion to operate, and covers of cylinder rods of the respective hydraulic cylinders.

The movable portion includes a boom 11, an arm 12, and a bucket 13.

Each of the hydraulic cylinders extends and contracts its overall length by causing a cylinder rod to come out of and into a cylinder tube by using hydraulic pressure to thereby cause the movable portion to operate and the hydraulic cylinders include a boom cylinder 21, an arm cylinder 22, and a bucket cylinder 23.

The boom cylinder 21 is mounted to a base A0 of the boom 11 and between the base A0 and a middle position A1 of the boom 11 and used to rotate the entire movable portion about the base A0.

The arm cylinder 22 is mounted between the middle position A1 and a position A2, where the boom 11 and the arm 12 are connected, and used to rotate the arm 12 and the portion on a front end side of the arm 12 about the connection position A2.

The bucket cylinder 23 is mounted between the connection position A2 and a position A3, where the arm 12 and the bucket 13 are connected, and used to rotate the bucket 13 about the connection position A3.

To the boom cylinder 21, the arm cylinder 22, and the bucket cylinder 23, cylinder rod covers 31, 32, and 33 are mounted, respectively.

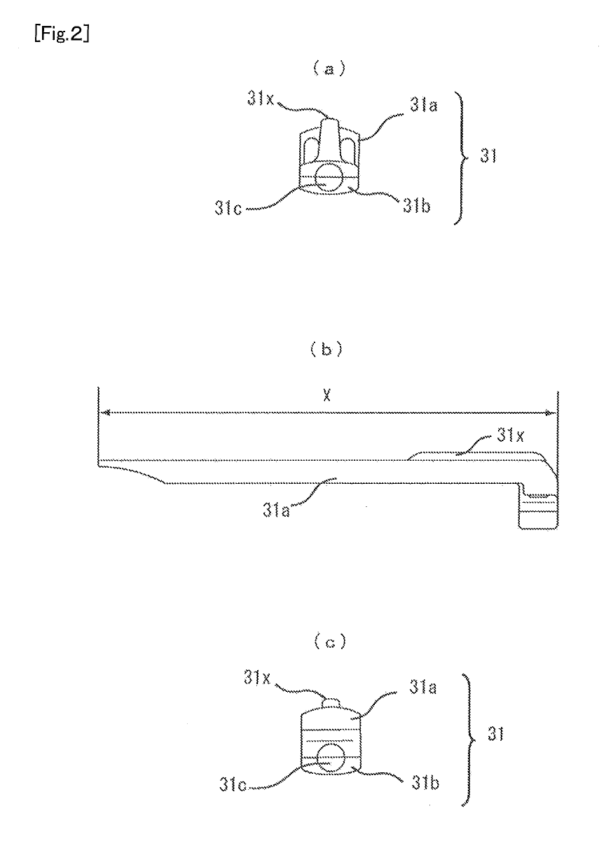

FIG. 2(a) is a front view showing an outward appearance of the cylinder rod cover 31, FIG. 2(b) is a side view of the same, and FIG. 2(c) is a back view of the same. Although outward appearances of the cylinder rod covers 32 and 33 shown in FIG. 1 may have different dimensions of respective portions according to sizes of the cylinders to which the covers are mounted, the covers 32 and 33 have similar shapes to the cylinder rod cover 31 and therefore will not be described. The cylinder rod cover 31 shown in FIG. 2 includes a cover main body 31a and a cover main body assisting portion 31b.

The cover main body 31a is in an L shape, has a mounting portion 31c to be fitted over a columnar outer face of a cylinder rod of the boom cylinder 21 shown in FIG. 1, and has a greater overall length X than a maximum exposed length of the cylinder rod of the boom cylinder 21. By setting the overall length X in this manner, it is possible to avoid an uncovered state of the cylinder rod to thereby prevent deformation and scratching of the cylinder rod when the cylinder rod comes in contact with an obstruction such as a construction, earth and sand, a rock, and a bucket of the work machine itself at a site. It is preferable to reinforce a surface of a portion of the cover main body 31a bent into the L shape in consideration of suppression of breakage and deformation of the cover main body 31a caused by reduction in strength due to the bending. To put it concretely, it is preferable to provide a thick-walled portion 31x made of the same material as the cover main body 31a to the surface of the cover main body 31a as shown in FIGS. 2(a) to 2(c).

The cover main body 31a is preferably made of raw material having a smaller specific gravity than iron. In this way, the cover main body 31a is lighter than the prior-art cover mainly made of iron and therefore can be easily supported by only the mounting portion 31c.

The cover main body 31a is preferably made of resin. In this way, it is possible to impart elasticity and resiliency to the cover main body 31a. As a result, the cover main body 31a can withstand a greater impact than the prior art and deformation of the cover main body 31a due to the impact can be minimized. Furthermore, the cover main body 31a is preferably made of transparent resin. In this way, when the cover main body 31a receives an impact and cracks, an inner crack can be visually recognized. Therefore, it is easy to know when it is time for replacement, which facilitates maintenance. Moreover, the cover main body 31a made of the transparent resin provides a wide vision, visually stimulates a sense of beauty, and attracts people's attention, which improves workability and safety and is expected to exert promotional effect. Specific examples of the resin to be used are polyethylene, polypropylene, acrylonitrile-butadiene-styrene resin copolymerized synthetic resin, acrylic resin, polyethylene terephthalate, polyvinyl chloride, polymethylpentene, and cycloolefin polymer.

Moreover, the cover main body 31a is preferably made of light and robust material such as polycarbonate, fiber reinforced plastic, and glass fiber. In this way, the cover main body 31a obtains high strength, though it is lightweight.

In consideration of improvement of impact resistance, workability, and safety, the cover main body 31a is the best preferably made of polyethylene, polypropylene, polycarbonate, acrylonitrile-butadiene-styrene copolymerized synthetic resin, fiber reinforced plastic, or glass fiber.

The mounting portion 31c, and specifically the cover main body assisting portion 31b is preferably fitted over the columnar outer face of the cylinder rod of the boom cylinder 21 shown in FIG. 1 so as to assist mounting of the cover main body 31a to the boom cylinder 21. The cover main body assisting portion 31b is preferably made of the same material as the cover main body 31a. On the other hand, the cover main body 31b may be intentionally made of more breakable material than the cover main body 31a. In this way, if an excessive external force acts on the cover main body 31a, the cover main body assisting portion 31b breaks first and only the broken cover main body assisting portion 31b may be replaced, which is economical and facilitates spare parts control.

Furthermore, the cover main body 31a and the cover main body assisting portion 31b are preferably made of such material that a manufacturing method such as injection molding with high mass productivity can be employed. Moreover, in consideration of increase in a temperature of an atmosphere caused by friction in a drive-train, the cover main body 31a and the cover main body assisting portion 31b are preferably made of material which can withstand an environment of about 150° C.

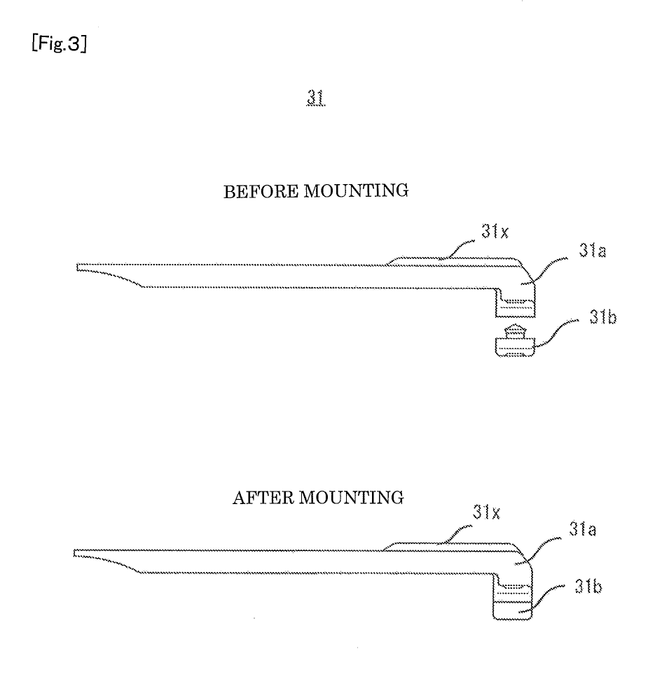

FIG. 3 is a diagram showing the cover 31 of the cylinder rod before and after mounting. To mount the cover 31 of the cylinder rod, the cover main body 31a and the cover main body assisting portion 31b are coupled to each other by fastening a coupling screw (not shown) at an end portion of the cylinder rod of the boom cylinder 21 shown in FIG. 1. As a result, the cover 31 of the cylinder rod of the boom cylinder 21 is fixed to the cylinder rod of the boom cylinder 21.

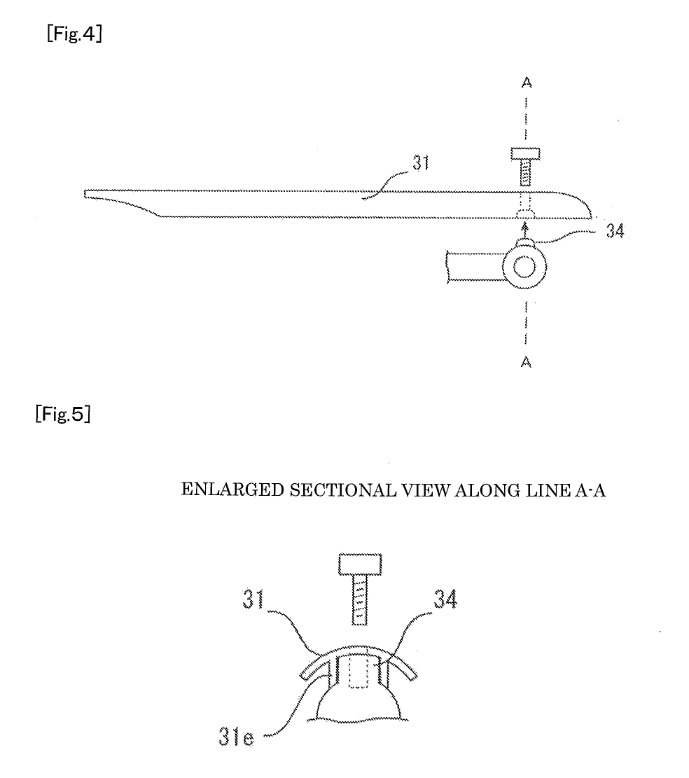

The shape of the cover main body is not limited to the L shape and may be a straight shape, for example, as shown in FIG. 4 in consideration of a structure of a cylinder rod (specifically, a structure of the clevis portion of the cylinder rod). In this case, a lower portion of a cover main body 31 and the clevis portion 34 of the cylinder rod are fitted with each other and the cover main body 31 and the cylinder rod are coupled to each other by fastening a bolt from above the cover main body 31.

FIG. 5 is an enlarged sectional view along line A-A in FIG. 4. A rectangular skirt portion 31e is formed on a back face of a tip end of the cover main body 31 so as to facilitate proper fitting of the clevis portion.

The present application claims benefit of priority based on Japanese Patent Application No. 2015-007023 filed on Jan. 16, 2015 the entire description of which is incorporated herein by reference.

### INDUSTRIAL APPLICABILITY

The cover of the cylinder rod according to the invention can be widely used for work machines such as crane trucks, loading shovels, and aerial work platforms.

### DESCRIPTION OF SYMBOLS

11 boom
12 arm
13 bucket
21 boom cylinder
22 arm cylinder
23 bucket cylinder
31 cover of boom cylinder rod
31a cover main body
31b cover main body assisting portion
31c mounting portion
31e skirt portion
31x thick-walled portion
32 cover of arm cylinder rod
33 cover of bucket cylinder rod
34 clevis portion
A0 base of boom
A1 middle position between base A0 of boom and boom 11
A2 connection position of boom 11 and arm 12
A3 connection position of arm 12 and bucket 13
X overall length of cover main body 31a

1-6. (canceled)

7. A cover of a cylinder rod provided to a work machine, comprising:
the cover of the cylinder rod is supported on a columnar outer face of the cylinder rod by one-point support with a mounting portion, which is joined only to an end portion of the cylinder rod directly,
furthermore, the cover and the cylinder tube kept out of contact for overall length regardless of direct or indirect without locating any guide material with an outer peripheral face of a cylinder tube,
and includes a cover main body having a greater length than a maximum exposed length of the cylinder rod.

8. The cover of the cylinder rod according to claim 7, wherein
the cover main body is made of material having a smaller specific gravity than iron.

9. The cover of the cylinder rod according to claim 8, wherein
the cover main body is preferably made of resin.

10. The cover of the cylinder rod according to claim 8, wherein
the cover main body is made of polyethylene, polypropylene, polycarbonate, acrylonitrile-butadiene-styrene resin copolymerized synthetic resin, fiber reinforced plastic, and glass fiber.

11. The cover of the cylinder rod according to claim 7, wherein
the mounting portion is fitted over the columnar outer face of the cylinder rod.
